(19) United States
(12) Patent Application Publication
(10) Pub. No.: US 2013/0263276 A1
(43) Pub. Date: Oct. 3, 2013

(54) INFORMATION PROCESSING APPARATUS, INFORMATION PROCESSING METHOD, INFORMATION PROCESSING SYSTEM, AND PROGRAM

(71) Applicant: SONY CORPORATION, Tokyo (JP)

(72) Inventors: Shinya Maruyama, Kanagawa (JP); Takanori Saneto, Tokyo (JP); Hisayuki Tateno, Kanagawa (JP); Takahiro Sakamoto, Tokyo (JP); Yukihiko Aoki, Tokyo (JP)

(73) Assignee: Sony Corporation, Tokyo (JP)

(21) Appl. No.: 13/792,301

(22) Filed: Mar. 11, 2013

(30) Foreign Application Priority Data
Mar. 30, 2012 (JP) 2012-080498

(51) Int. Cl. G06F 21/62

(52) U.S. Cl. CPC G06F 21/6245
USPC 726/26

(57) ABSTRACT

Devices, methods, and programs for controlling disclosure of information or data. Disclosure to a first user of data provided by a third user may be controlled based, at least in part, on first information indicating a closeness of a relationship between the first user and a second user who is a subject of the data.

### RELATED APPLICATIONS

The present application claims the priority benefit of Japanese Priority Patent Application JP 2012-080498, filed in the Japan Patent Office on Mar. 30, 2012, which is hereby incorporated by reference in its entirety.

### BACKGROUND

The present disclosure relates to an information processing apparatus, an information processing method, an information processing system, and a program.

In recent years, a service has been in widespread use which enables easy sharing of information. For example, in a membership-based service such as a social networking service (SNS), photographs, videos, documents, and the like can easily be made public and shared. In the case where personal information is contained in the information that is made public, it becomes important to control a disclosure state of the personal information.

For example, JP 2010-539565T discloses a system capable of setting an access right to data managed by a user, on a per-user basis.

### SUMMARY

However, in the above-mentioned system, a user to whom the personal information belongs cannot control the disclosure state of personal information that is made public by another person.

In light of the foregoing, it is desirable to control the disclosure state of personal information based on a relationship between an attribution user to whom the personal information belongs and an access user who accesses the personal information.

According to an embodiment of the present disclosure, there is provided a method including: controlling disclosure of data to a first user based, at least in part, on first information indicating a closeness of a relationship between the first user and a second user, wherein the second user is a subject of the data, and wherein the data is provided by a third user.

In some embodiments, the disclosure of the data to the first user is further controlled based on second information indicating a reliability of third information, and the third information specifies that the second user is a subject of the data.

According to another embodiment of the present disclosure, there is provided a method including: controlling disclosure of data to a first user based, at least in part, on first information indicating a closeness of a relationship between the first user and a second user, and on second information indicating a reliability of third information, wherein the third information specifies that the second user is a subject of the data.

According to another embodiment of the present disclosure, there is provided a computer-readable storage medium having recorded thereon a program which, when executed by a computer, causes the computer to perform a method including: controlling disclosure of data to a first user based, at least in part, on first information indicating a closeness of a relationship between the first user and a second user, wherein the second user is a subject of the data, and wherein the data is provided by a third user.

According to another embodiment of the present disclosure, there is provided an apparatus including: at least one processor; and a computer-readable storage medium storing a program which, when executed by the at least one processor, performs a method. The method includes controlling disclosure of data to a first user based, at least in part, on first information indicating a closeness of a relationship between the first user and a second user, and on second information indicating a reliability of third information, wherein the third information specifies that the second user is a subject of the data.

### BRIEF DESCRIPTION OF THE DRAWINGS

FIG. 1 is an explanatory diagram showing a configuration of an information processing system according to an embodiment of the present disclosure;

FIG. 2 is a block diagram showing a functional configuration example of a server device according to the embodiment;

FIG. 3 is a flowchart showing an example of SNS friend registration processing of the information processing system according to the embodiment;

FIG. 4 is a flowchart showing an example of personal information-uploading processing of the information processing system according to the embodiment;

FIG. 5 is a flowchart showing a first example of personal information-access control processing of the information processing system according to the embodiment;

FIG. 6 is an explanatory diagram showing an overview of the first example of personal information-access control of the information processing system according to the embodiment;

FIG. 7 is an explanatory diagram showing a disclosure state in the first example of personal information-access control of the information processing system according to the embodiment;

FIG. 8 is a flowchart showing a second example of personal information-access control processing of the information processing system according to the embodiment;

FIG. 9 is an explanatory diagram showing a disclosure state in the second example of personal information-access control of the information processing system according to the embodiment;

FIG. 10 is an explanatory diagram showing a third example of personal information-access control of the information processing system according to the embodiment;

FIG. 11 is an explanatory diagram showing a fourth example of personal information-access control of the information processing system according to the embodiment;

FIG. 12 is an explanatory diagram showing a disclosure state in the fourth example of personal information-access control of the information processing system according to the embodiment;

FIG. 13 is an explanatory diagram showing a fifth example of personal information-access control of the information processing system according to the embodiment;

FIG. 14 is an explanatory diagram showing a disclosure state in the fifth example of personal information-access control of the information processing system according to the embodiment;

FIG. 15 is a block diagram showing an example of a hardware configuration of the server device according to the embodiment;

FIG. 16 is an explanatory diagram illustrating an example of disclosure of personal information in an SNS of the past; and

FIG. 17 is an explanatory diagram showing an example of access control to the personal information of FIG. 16.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. Overview

2. Functional Configuration Example

3. Operation Example

4. Access Control Example

5. Hardware Configuration Example

6. Conclusion

### 1. OVERVIEW

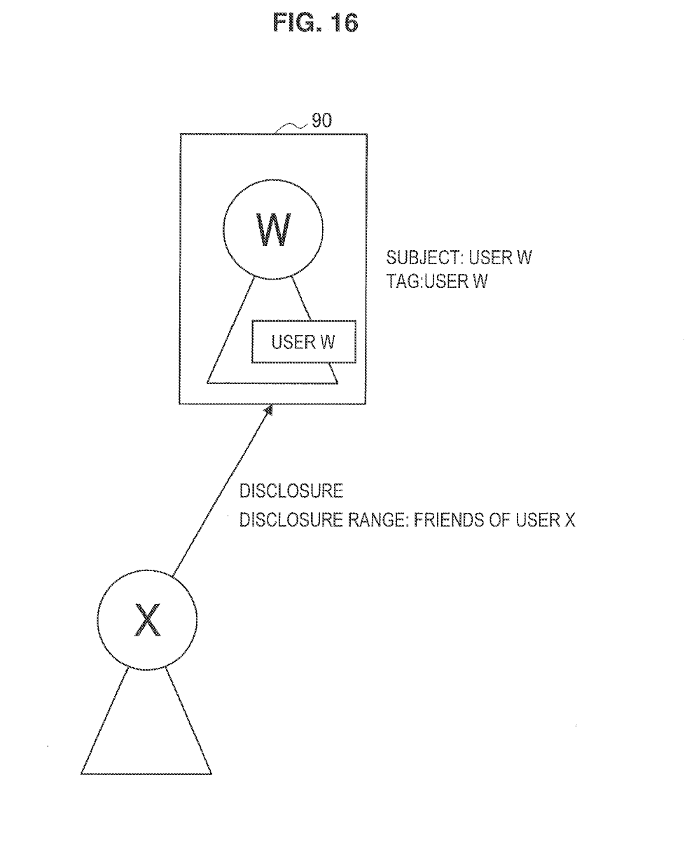

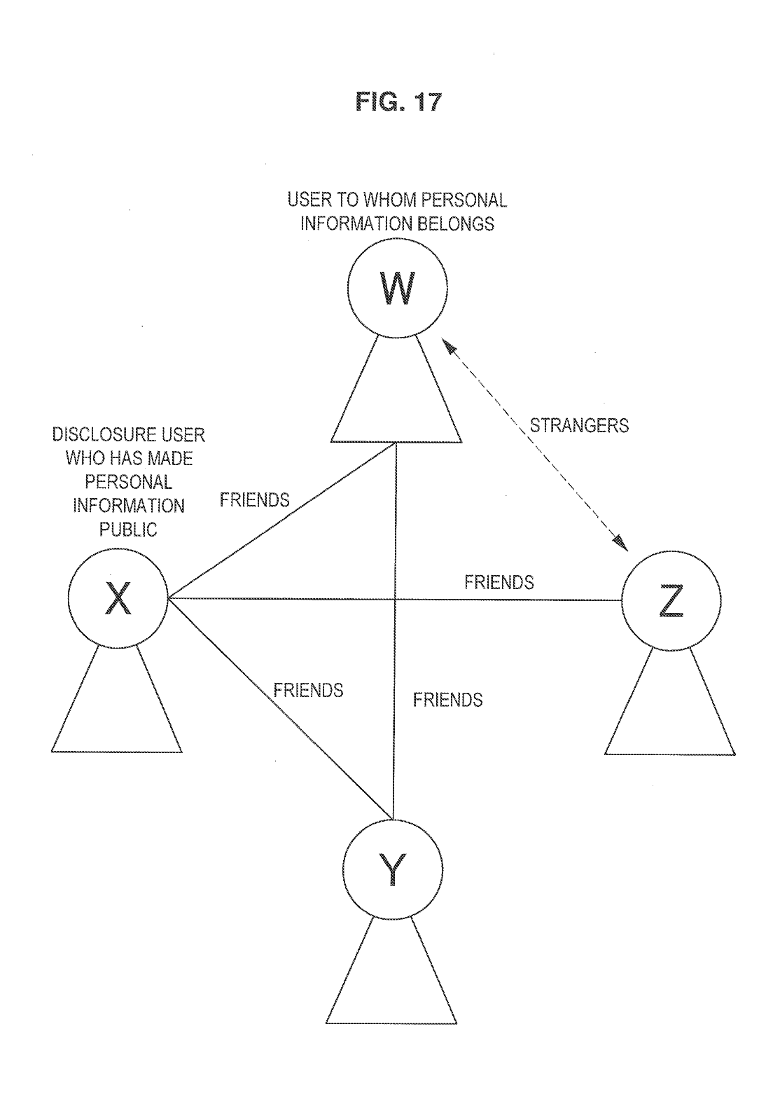

First, by comparing with a system of the past with reference to FIG. 16 and FIG. 17, there will be described an overview of an information processing system according to an embodiment of the present disclosure. FIG. 16 is an explanatory diagram illustrating an example of disclosure of personal information in an SNS of the past. FIG. 17 is an explanatory diagram showing an example of access control to the personal information of FIG. 16.

The information processing system according to an embodiment of the present disclosure can provide membership-based service such as an SNS. In such a service, anyone can easily make public and share data containing personal information. For example, as an example of the data containing personal information, there is given a tag added to a photograph. The tag is information associated with a specific user, and is used for specifying, by adding the tag to a subject shown in the photograph, who the subject is. In recent years, since a membership-based service has been in widespread use in which real names are made public, the significance of handling of personal information is further increasing.

For example, when using an SNS, the data containing personal information can be made public by a person other than a user to whom the personal information belongs. Referring to FIG. 16, an example of such a case of making information public is shown. For example, as shown in FIG. 16, let us assume a case where a tag specifying “user W” is added to an image 90 in which a user W is shown as a subject and a user X makes the image 90 public. In this case, the user X sets the disclosure range with respect to the image 90 to friends of the user X.

As shown in FIG. 17, among the friends of the user X who is a disclosure user who makes the personal information public, there is included a user such as a user Y who is also a common friend with the user W who is an attribution user to whom the personal information belongs. Further, among the friends of the user X, there is also included a user Z who is a stranger to the user W. In this case, although the user Z is a stranger to the user W who is the attribution user, the user Z can view the personal information of the user W.

In the state where the tag is not added, the user Y can specify the subject shown in the image 90 as the user W, but it is supposed that the user Z cannot specify the subject shown in the image 90 as the user W. However, by the user X adding the tag, the user Z who is a stranger to the user X can also specify that the subject shown in the image 90 is the user W.

Further, although the user W and the user Z are strangers to each other based on the information registered in the SNS, let us assume a case where the user W and the user Z are actually acquaintances with each other. Since the user W does not want to share information with the user Z, the user W does not register the user Z as a friend on the SNS. In this case, as for information made public by the user W himself/herself, the user Z cannot access the information. However, as described above, as for information of the user W made public by the user X, the user Z can access the information.

This is because that access control to the personal information is performed not based on the user to whom the personal information belongs, but based on the relationship between the disclosure user and the access user. Accordingly, the present disclosure suggests access control based on a distance between a user to whom the personal information belongs and an access user.

### 2. FUNCTIONAL CONFIGURATION EXAMPLE

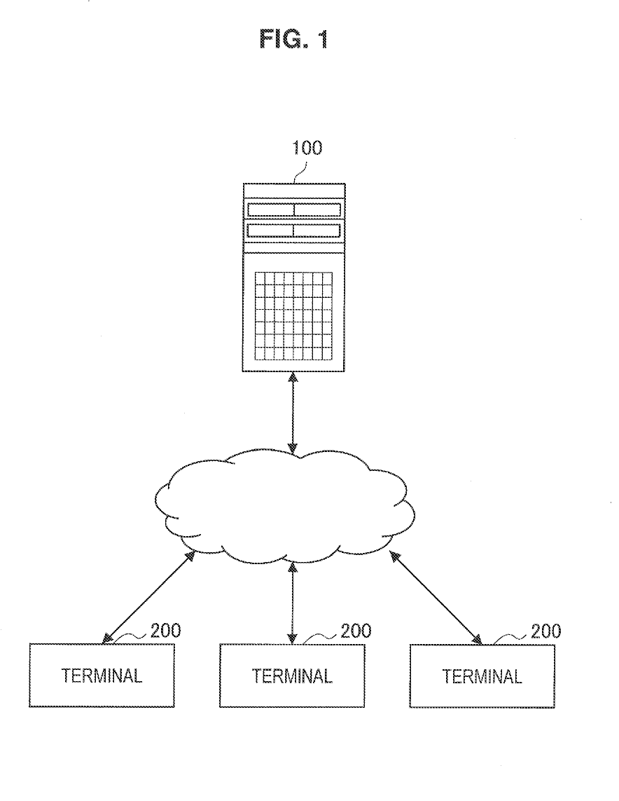

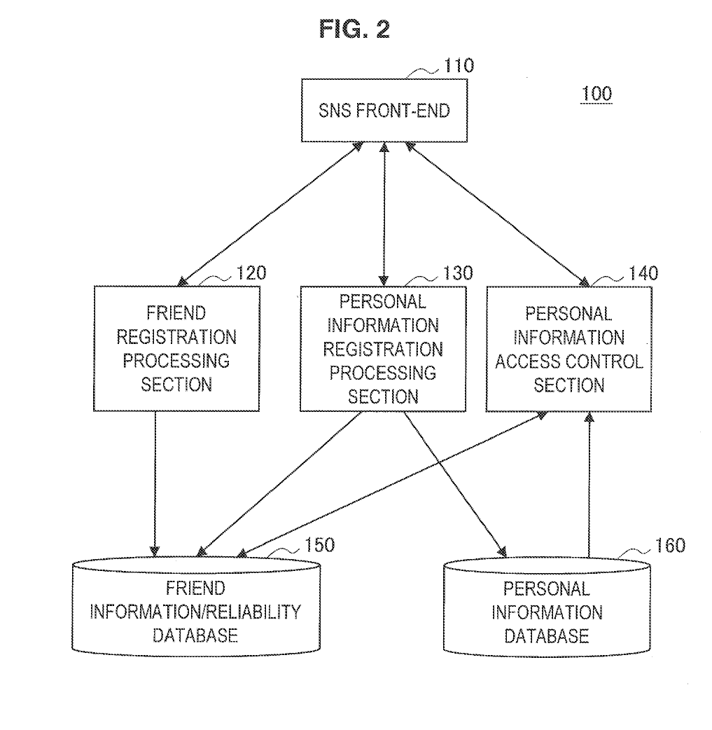

Next, with reference to FIG. 1 and FIG. 2, a functional configuration example of an information processing system according to an embodiment of the present disclosure will be described. FIG. 1 is an explanatory diagram showing a configuration of an information processing system according to an embodiment of the present disclosure. FIG. 2 is a block diagram showing a functional configuration example of a server device according to the embodiment.

### 2-1. Configuration of System

First, with reference to FIG. 1, a configuration of an information processing system for providing an SNS according to an embodiment of the present disclosure will be described.

The information processing system according to the embodiment mainly includes a server device 100 which provides an SNS, and a terminal device 200 which uses the SNS. The server device 100 has various functions for providing the SNS. Note that the server device 100 is configured from one piece of hardware in FIG. 1, but is not limited thereto, and the functions of the server device 100 can be realized using multiple pieces of hardware.

Further, the terminal device 200 is a device having a function of accessing an SNS provided by the server device 100 via a network. The terminal device 200 may be an information processing apparatus including, for example, a mobile phone including a smartphone, a personal computer (PC), a television receiver, a game console, a music playback device, a video processing device, and a household electrical appliance.

### 2-2. Configuration of Server

Next, with reference to FIG. 2, a functional configuration of the server device 100 will be described. The server device 100 provides a function that an SNS-registered user can make public a user profile, posted documents including diaries, photographs, and videos, for example. Further, the registered user can register relationships with other registered users. For example, when a registered user b sends a friend request to another registered user c and the request is approved by the registered user c, the registered user b and the registered user c can be connected to each other as friends. In the following, the configuration of the server device 100 for providing such a function of the SNS will be described.

The server device 100 mainly includes an SNS front-end 110, a friend registration processing section 120, a personal information registration processing section 130, a personal information access control section 140, a friend information/reliability database 150, and a personal information database 160.

(SNS Front-End 110)

The SNS front-end 110 has a function of accepting access from the terminal device 200. When accepting access from the terminal device 200, the SNS front-end 110 executes user ID-authentication processing, for example. Further, the SNS front-end 110 can provide the terminal device 200 with various display screens based on operation performed by a user of the terminal device 200. The SNS front-end 110 can pass, in accordance with the user operation, for example, information or the like input by the user to the friend registration processing section 120, the personal information registration processing section 130, and to the personal information access control section 140, for example.

(Friend Registration Processing Section 120)

The friend registration processing section 120 has a function of generating and registering friend information of a user in accordance with user operation. For example, the friend registration processing section 120 can generate information indicating that two users are friends based on information input by the user of the terminal device 200. Further, the friend registration processing section 120 can set a reliability between users, and can register the reliability in the friend information/reliability database 150. Here, the reliability is an example of a value indicating a distance between users. Note that the reliability may be set based on the user's input. For example, the user can set the reliability between users by using settings at the time of service registration or selecting a settings menu item. Alternatively, the reliability may be set automatically. The friend registration processing section 120 can automatically set the reliability by converting the reliability into a numerical value using, for example, user information and service usage status.

Note that, in the case where the reliability is to be automatically set, the following may be used for example: information on where a user belongs (school from which the user had graduated and where the user works at); and profile information of the user, such as age. Further, an analysis result obtained by analyzing data such as a photograph, video, and text may be used for the settings of the reliability. For example, it may be determined that users are in close relationship with each other when the frequency that they appear in the same photograph is high. Further, it may be determined that a user who appears in a positive sentence of a text is in close relationship with a user who has written the sentence.

Further, the settings of the reliability may be executed, in addition to on a per-user basis, on a per-group basis in which multiple users are gathered. The data on which the access control is performed includes entire pieces of electronic data handled by a service such as an SNS. Further, the data on which the access control is performed may include multiple pieces of personal information of different users.

(Personal Information Registration Processing Section 130)

The personal information registration processing section 130 has a function of performing personal information-registration processing. The personal information-registration processing includes personal information-uploading processing and processing of registering a reliability with respect to the personal information. Here, the reliability with respect to the personal information may be set based on a reliability between an attribution user to whom the personal information belongs and a disclosure user who makes the personal information public. Note that the personal information registration processing section 130 can also have a function of a control section that controls a disclosure state of the personal information. That is, the personal information registration processing section 130 determines whether to upload the personal information based on the reliability between the attribution user and the disclosure user, and thus, the disclosure state of the personal information may be controlled.

(Personal Information Access Control Section 140)

The personal information access control section 140 has a function of performing access control to personal information. The personal information access control section 140 determines whether to permit access to the personal information, and thus being capable of controlling the disclosure state of the personal information. The personal information access control section 140 can determine access availability based on a reliability between an attribution user of personal information (e.g., a subject of the personal information) and an access user. Note that there are considered various methods for the access control performed by the personal information access control section 140. For example, the access control may be performed based on the access availability to data itself to which the personal information is added. Further, the access control may be performed only to a part corresponding to the personal information. For example, in the case where the personal information is a tag added to an image, the access control may be performed in a manner of displaying or not displaying the tag. Further, the access control may be performed in a manner of permitting or not permitting the access to the image itself to which the tag is added. Alternatively, to a user to whom access is not permitted, the tag may not be displayed and further, an image in a state where a subject is blurred may be displayed.

(Friend Information/Reliability Database 150)

The friend information/reliability database 150 is a database for storing friend information and a reliability between users. For example, the friend information/reliability database 150 can store a relationship between users and a reliability obtained by converting a distance between the users into a numerical value.

(Personal Information Database 160)

The personal information database 160 is a database for storing personal information of a user. The personal information stored in the personal information database 160 may be data including photographs, videos, texts, and the like, and tag information added to those pieces of data. In addition, the personal information database 160 can further store therein a reliability added to the personal information.

Heretofore, examples of functions of the server device 100 according to the present embodiment have been shown. Each of the above structural elements may be configured using general-purpose members or circuits, or may be configured using hardware specialized for the function of each structural element. Further, the function of each structural element may be realized by reading, by an arithmetic unit such as a CPU (Central Processing Unit), a control program from the storage medium such as a ROM (Read Only Memory) or a RAM (Random Access Memory) that stores the control program in which procedures for realizing those functions are written, and by interpreting and executing the program. Therefore, the configuration to be used can be changed appropriately in accordance with the technical level each time when the embodiment is carried out.

Note that there may be produced a computer program for realizing respective functions of the server device 100 according to the present embodiment as described above, and the computer program can be implemented in a personal computer or the like. Further, there can also be provided a computer-readable recording medium having the computer program stored therein. Examples of the recording medium include a magnetic disk, an optical disc, a magneto-optical disk, and a flash memory. Further, the computer program may be distributed via a network, without using the recording medium, for example.

### 3. OPERATION EXAMPLE

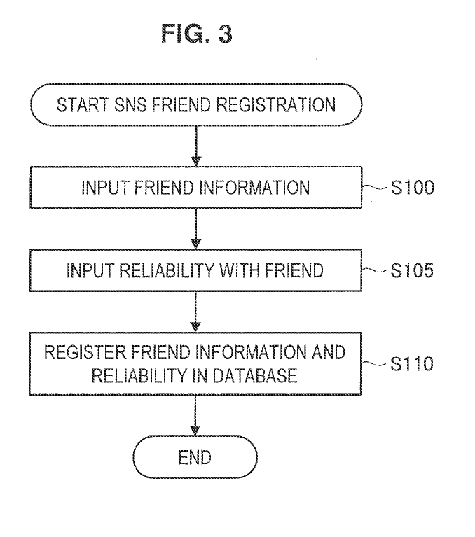

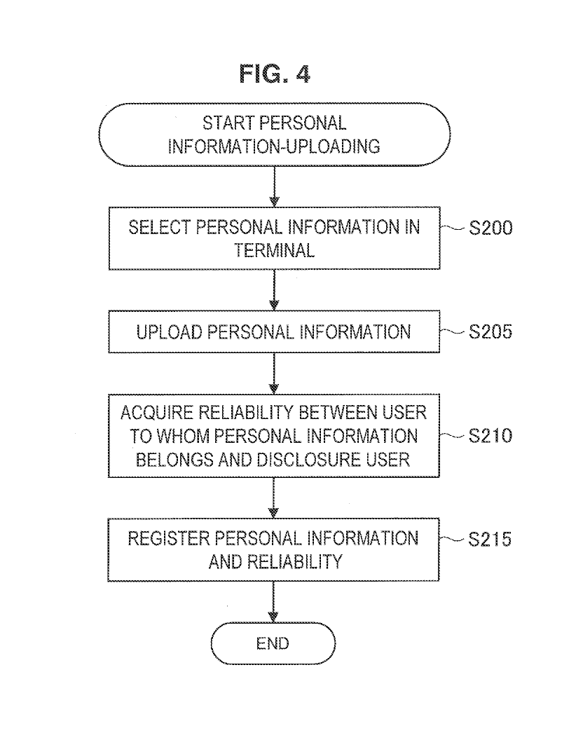

Next, with reference to FIG. 3 and FIG. 4, an operation example of an information processing apparatus according to an embodiment of the present disclosure will be described. FIG. 3 is a flowchart showing an example of SNS friend registration processing of the information processing system according to the embodiment. FIG. 4 is a flowchart showing an example of personal information-uploading processing of the information processing system according to the embodiment.

### 3-1. SNS Friend Registration Processing

First, referring to FIG. 3, there is shown an example of SNS friend registration processing. A user inputs friend information via the terminal device 200 (S100). Then, the user further inputs a reliability with the friend (S105). The friend registration processing section 120 registers the friend information and the reliability which have been input in Step S100 and Step S105, respectively, in the friend information/reliability database 150 (S110).

### 3-2. Personal Information-Uploading Processing

Next, referring to FIG. 4, there is shown a first example of personal information-uploading processing. First, the user selects personal information that is present inside the terminal device 200 (S200). Then, the user uploads the selected personal information (S205). The personal information registration processing section 130 acquires a reliability between an attribution user to whom the uploaded personal information belongs and a disclosure user who has uploaded the personal information (S210). After that, the personal information registration processing section 130 sets the acquired reliability as the reliability of the uploaded personal information, and registers the personal information and the reliability in the personal information database 160 (S215).

### 4. ACCESS CONTROL EXAMPLE

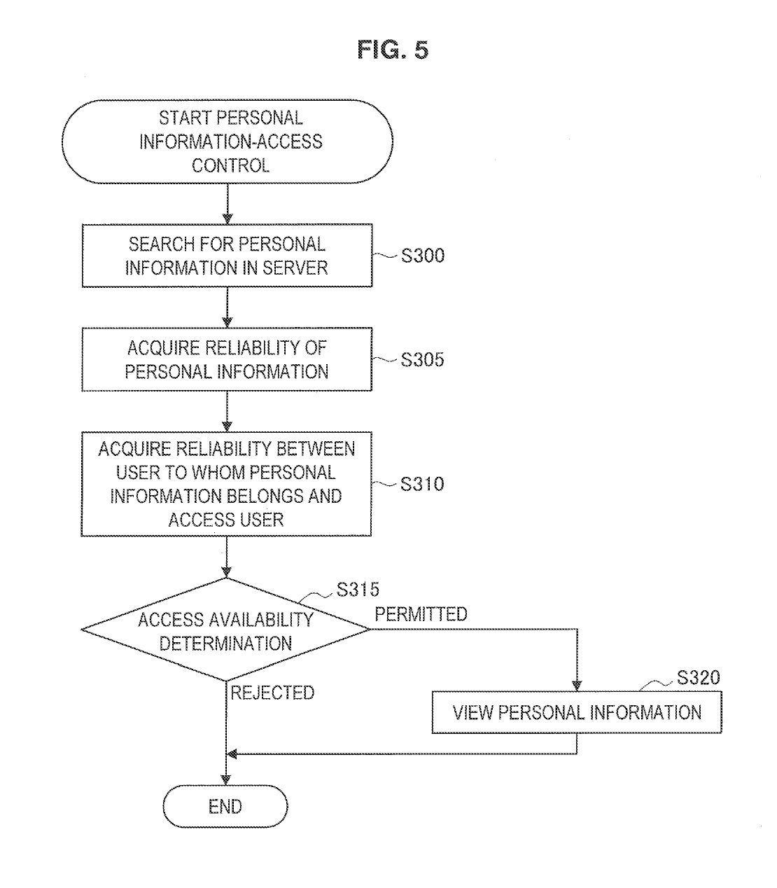

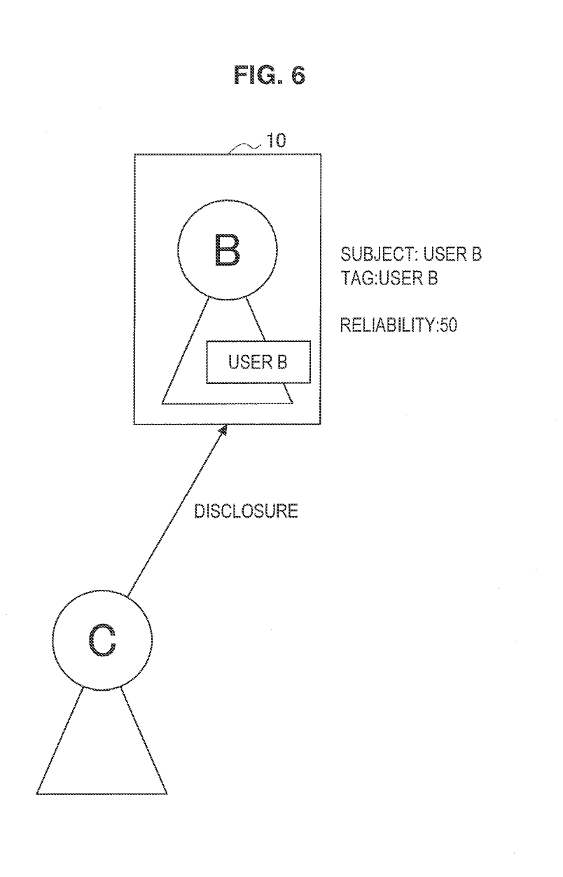

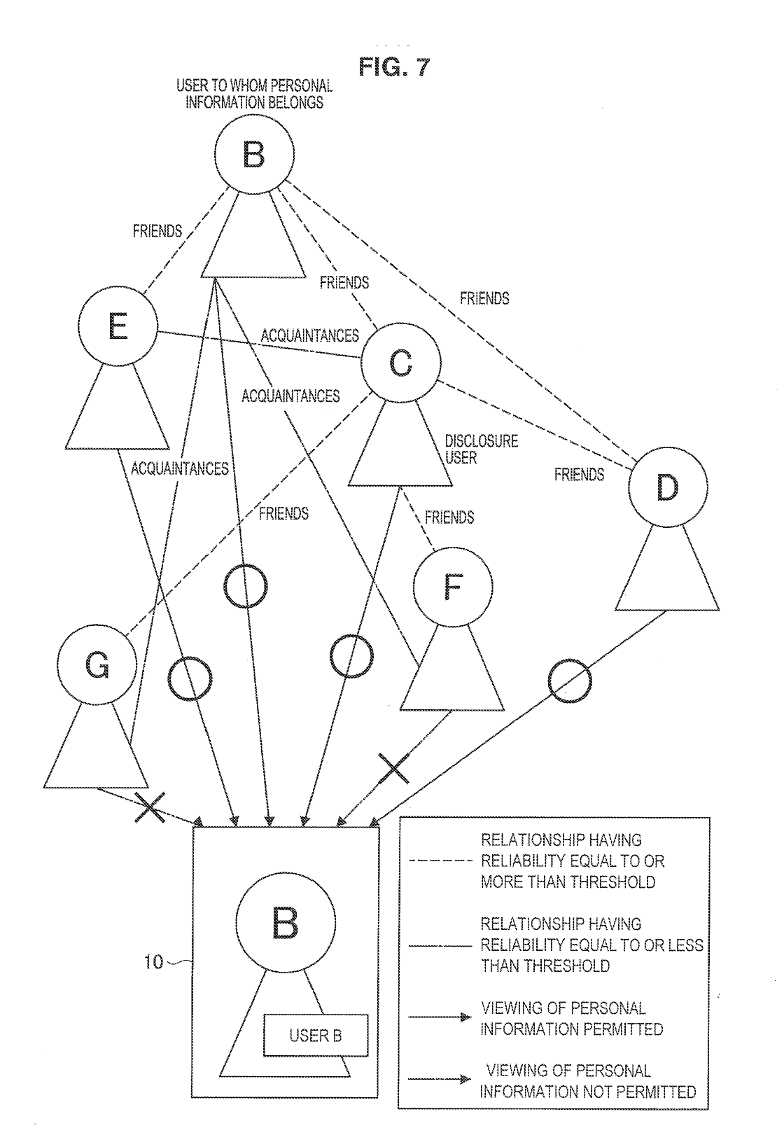

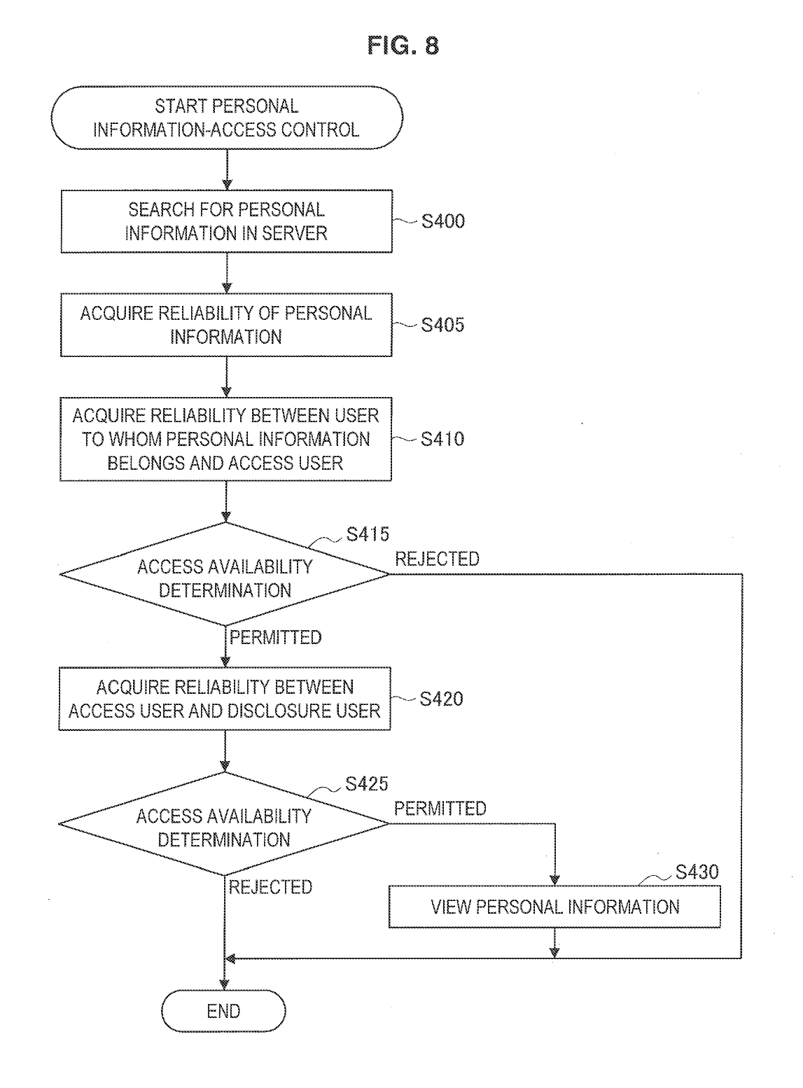

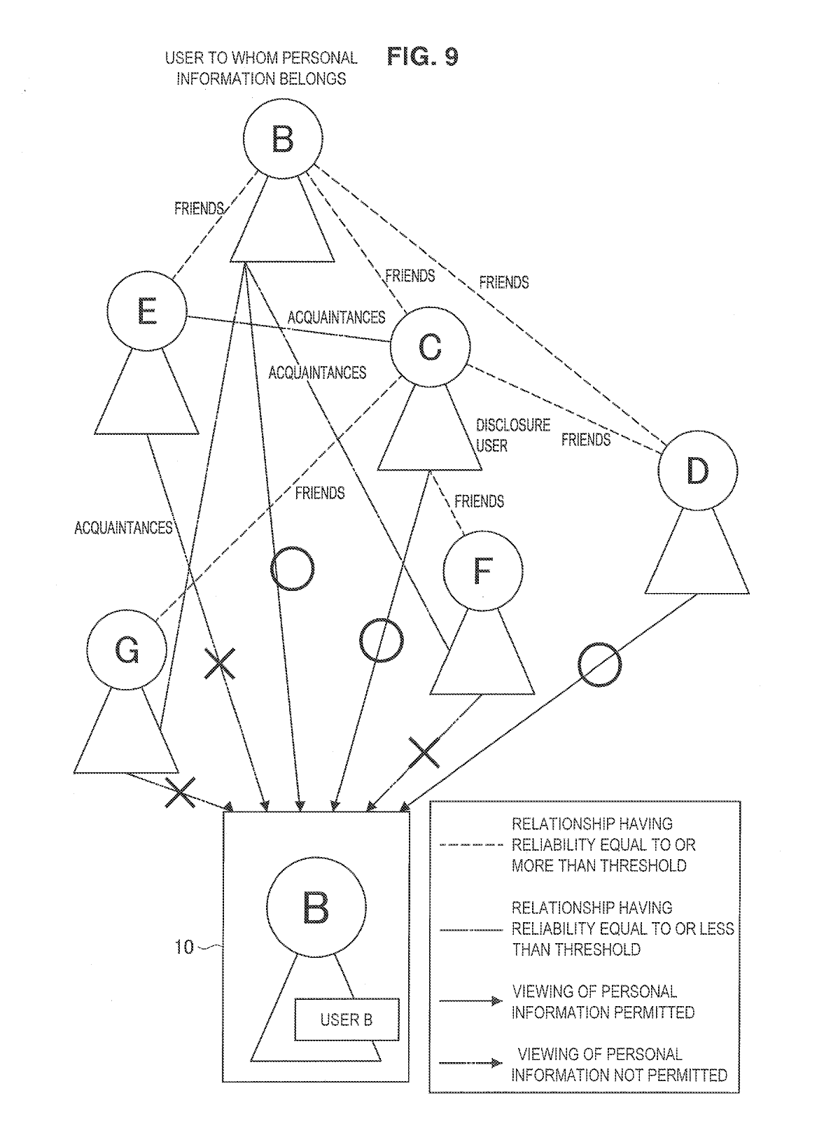

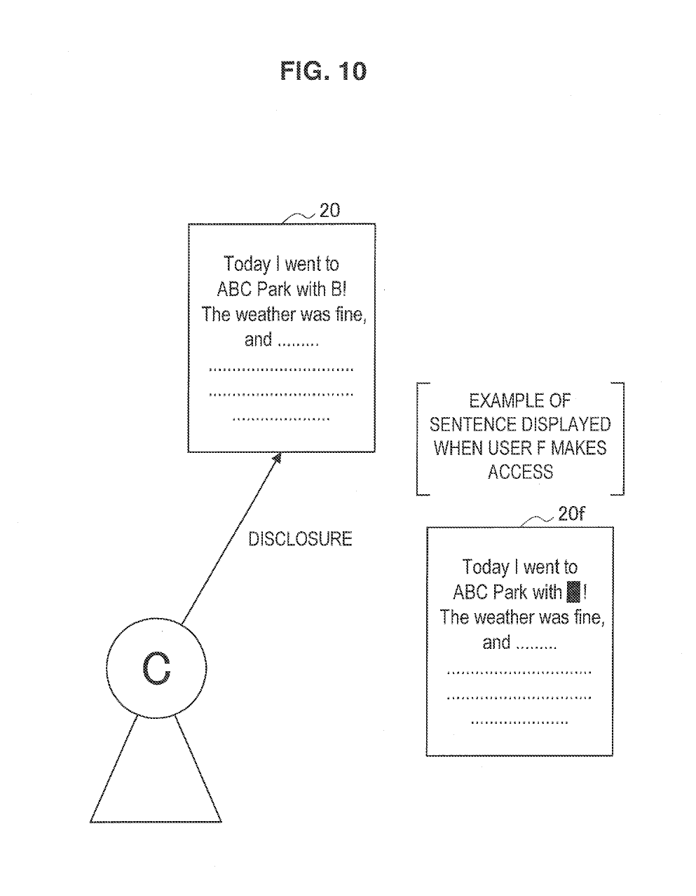

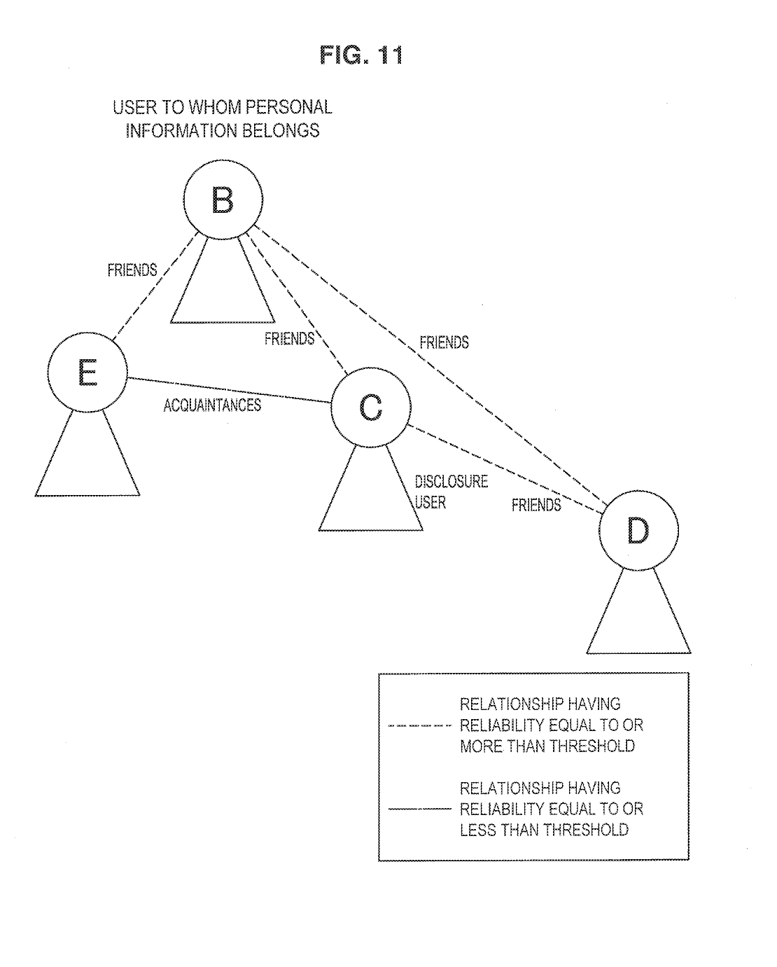

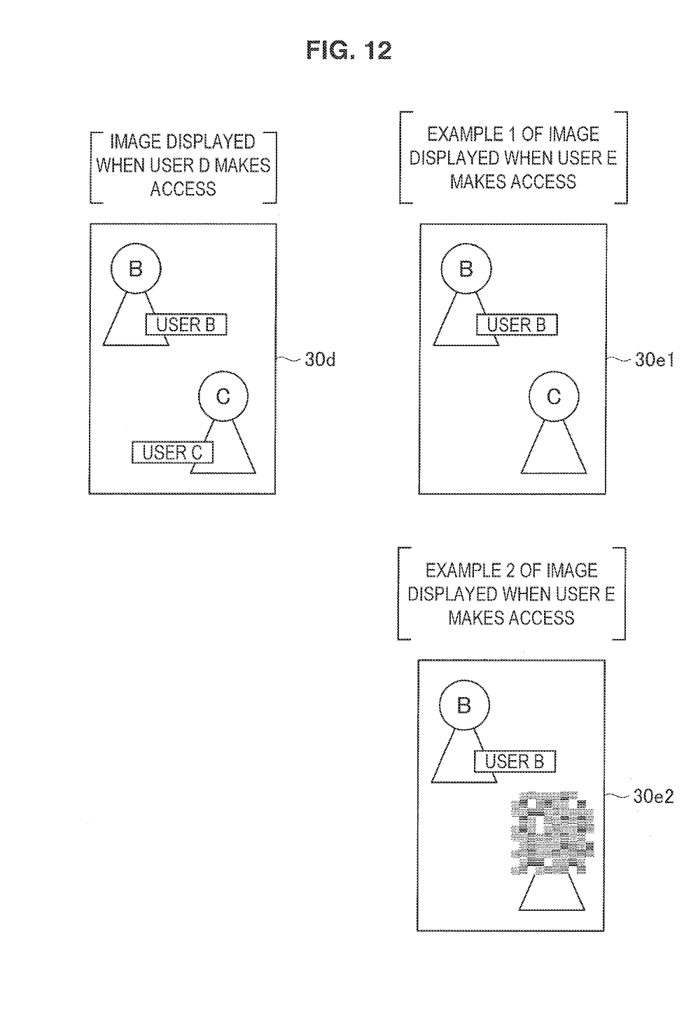

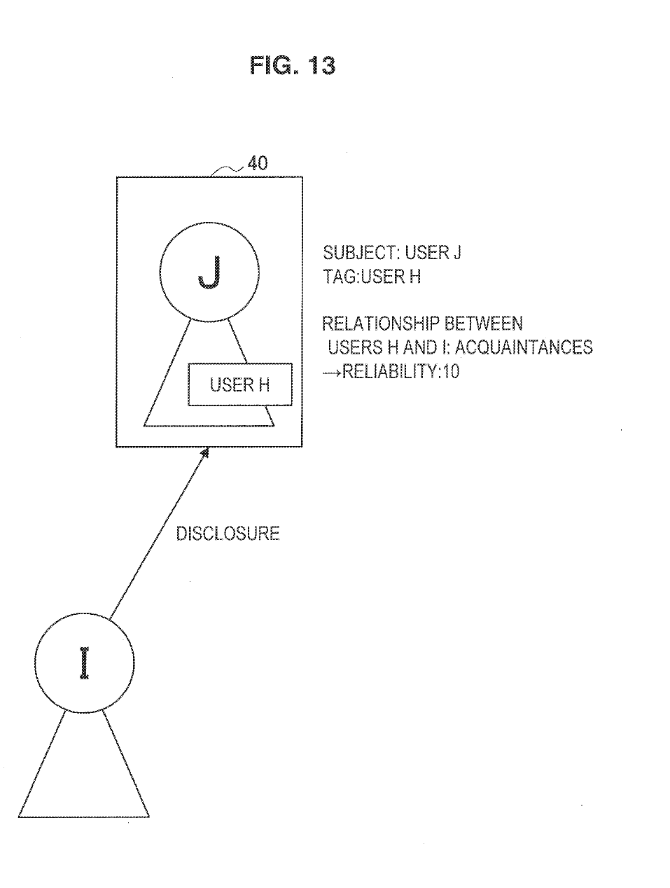

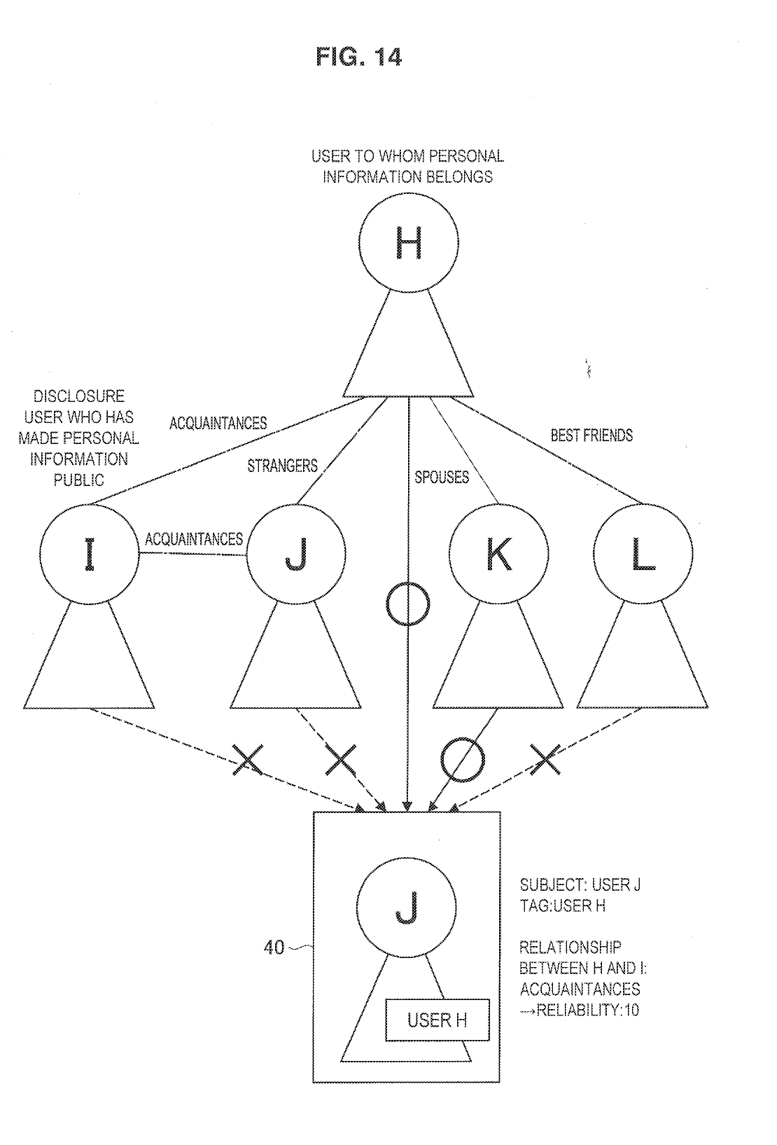

Next, personal information-access control of an information processing system according to an embodiment of the present disclosure will be described with reference to FIGS. 5 to 14 by way of multiple examples. FIG. 5 is a flowchart showing a first example of personal information-access control processing of the information processing system according to the embodiment. FIG. 6 is an explanatory diagram showing an overview of the first example of personal information-access control of the information processing system according to the embodiment. FIG. 7 is an explanatory diagram showing a disclosure state in the first example of personal information-access control of the information processing system according to the embodiment. FIG. 8 is a flowchart showing a second example of personal information-access control processing of the information processing system according to the embodiment. FIG. 9 is an explanatory diagram showing a disclosure state in the second example of personal information-access control of the information processing system according to the embodiment. FIG. 10 is an explanatory diagram showing a third example of personal information-access control of the information processing system according to the embodiment. FIG. 11 is an explanatory diagram showing a fourth example of personal information-access control of the information processing system according to the embodiment. FIG. 12 is an explanatory diagram showing a disclosure state in the fourth example of personal information-access control of the information processing system according to the embodiment. FIG. 13 is an explanatory diagram showing a fifth example of personal information-access control of the information processing system according to the embodiment. FIG. 14 is an explanatory diagram showing a disclosure state in the fifth example of personal information-access control of the information processing system according to the embodiment.

### 4-1. First Example

First, referring to FIG. 5, there is shown an example of personal information-access control processing. First, the personal information access control section 140 searches for personal information in response to access from a user (S300). Then, the personal information access control section 140 acquires reliability that is added to the personal information from the personal information database 160 (S305). Further, the personal information access control section 140 acquires a reliability between a user to whom the personal information belongs and an access user from the friend information/reliability database 150 (S310). The personal information access control section 140 determines whether to permit the access based on the acquired reliability (S315). Then, in the case where the access is permitted in the determination of Step S315, the user can view the personal information (S320).

Note that there are considered various methods of providing information in the case where the access is rejected. For example, to the user to whom the access is rejected, data itself including the personal information may not be provided. Further, only a part corresponding to the personal information within the data may not be provided to the user to whom the access is rejected. For example, let us assume a case the personal information is a tag and the tag is added to an image. In this case, the user to whom the access is rejected may be in a state of not being able to access the image itself. Further, in this case, the disclosure state of the personal information may be controlled in a manner that the image is provided but the tag is not shown to the user to whom the access is rejected.

Here, as shown in FIG. 6, let us assume a case where a subject is a user B, and a user C makes public an image 10 to which a tag showing that the subject is the user B is added. Here, let us assume that the reliability added to the image 10 is 50.

Here, the user B and the user C are friends with each other, the user B and a user D are friends with each other, the user B and a user E are friends with each other, the user B and a user F are acquaintances with each other, the user B and a user G are acquaintances with each other, the user C and the user D are friends with each other, the user C and the user E are acquaintances with each other, the user C and the user F are friends with each other, and the user C and the user G are friends with each other.

In this case, the reliability of data that is available for viewing by the access user is as shown in the following Table 1, based on the relationship between an attribution user and an access user.

| Relationship between attribution user | Reliability of data available |
|---|---|
| and access user | for viewing |
| User himself/herself | 0-100 |
| Spouses, Parent/Child | 10-100 |
| Best friends | 20-100 |
| Friends | 50-100 |
| Acquaintances | 90-100 |
| Strangers | 100-100 |

The disclosure state of the image 10 in this case is shown in FIG. 7. Here, access control is performed based on the reliability between the user to whom the personal information belongs and the access user. Accordingly, the access to the image 10 is permitted to the user B, the user C, the user D, and the user E, who are each in a data-viewing available relationship, the data of the image 10 having the reliability of 50.

### 4-2. Second Example

In the first example described above, the access control to the personal information has been performed based on the reliability between the attribution user and the access user. In contrast, the access control may also be performed further based on a reliability between a disclosure user and an access user.

Referring to FIG. 8, there is shown a second example of the personal information-access control processing. First, the personal information access control section 140 searches for personal information in response to access from a user (S400). Then, the personal information access control section 140 acquires a reliability that is added to the personal information from the personal information database 160 (S405). Further, the personal information access control section 140 acquires a reliability between a user to whom the personal information belongs and an access user from the friend information/reliability database 150 (S410). The personal information access control section 140 determines whether to permit the access based on the acquired reliability (S415). Then, in the case where the access is permitted in the determination of Step S415, the personal information access control section 140 then acquires a reliability between the access user and a disclosure user (S420). After that, the personal information access control section 140 determines whether to permit the access based on the reliability between the access user and the disclosure user (S425). Then, in the case where the access is permitted in the determination of Step S425, the user can view the personal information (S430).

Here, referring to FIG. 9, the disclosure state of the image 10 in the second example is shown. Here, the viewing of the image 10 is permitted only when the reliability with the attribution user B and the reliability with the disclosure user C are both equal to or more than a threshold. Accordingly, the user E, who is a friend of the user B who is the attribution user but is an acquaintance of the user C who is the disclosure user, cannot view the image 10. Further, the user D, who is a friend of the user B and is also a friend of the user C, can view the image 10.

Note that, in this case, the reliability of data that is available for viewing by the access user is as shown in the following Table 2, based on the relationship between a disclosure user and an access user.

| Relationship between disclosure user | Reliability of data available |
|---|---|
| and access user | for viewing |
| User himself/herself | 0-100 |
| Spouses, Parent/Child | 10-100 |
| Best friends | 20-100 |
| Friends | 50-100 |
| Acquaintances | 90-100 |
| Strangers | 100-100 |

### 4-3. Third Example

Next, with reference to FIG. 10, a third example of the personal information-access control of the information processing system according to the present embodiment will be described. In the first example of and the second example described above, the references used for determining the access availability have been shown as examples, but in here, the description will be made focused on a disclosure method of a case where it is determined that the access is not permitted, by using as an example a case where the data to be made public is a sentence.

For example, let us assume that the user C makes a sentence 20 public as shown in FIG. 10, for example. Here, the contents of the sentence 20 include a content related to the user B, as follows: “Today I went to ABC Park with B! The weather was fine, and . . . . ” That is, the user to whom personal information belongs included in the sentence is the user B. Here, when the user F accesses the sentence 20, the sentence 20 may be displayed as shown in a sentence 20f, for example. Here, the relationship between the users is as shown in FIG. 7 or FIG. 9. In this case, the user F is a friend of the user C, and is an acquaintance of the user B. In the case where the reliability added to the sentence 20 is 50, the access of the user F to the sentence 20 is not permitted. The personal information access control section 140 may control the disclosure state of the personal information in a manner that the user F cannot display the sentence 20 itself. Alternatively, as shown in FIG. 10, the personal information access control section 140 may control the disclosure state of the personal information in a manner that the user F is provided with the sentence 20f in which only a part corresponding to the personal information within the sentence 20 is blacked out.

### 4-4. Fourth Example

Next, with reference to FIG. 11 and FIG. 12, a fourth example of the personal information-access control of the information processing system according to the present embodiment will be described. Note that, in the third example described above, the case where the data to be made public is a sentence has been described as an example, but in here, the description will be made focused on a disclosure method of a case where it is determined that the access is not permitted when a tag added to an image is personal information and multiple subjects are included in the image.

Here, relationships between users are shown again in FIG. 11. The user B and the user C are friends with each another, the user B and the user D are friends with each another, and the user B and the user E are friends with each another. Further, the user C and the user D are friends with each another, and the user C and the user E are acquaintances with each other. In this case, let us assume that an image 30 includes the user B and the user C as subjects. Tags are added to the user B and the user C, respectively.

Under such a status, in the case where the user D, who is a friend of both the user B and the user C and is permitted to access the personal information, accesses the image 30, the tag of the user B and the tag of the user C may both be displayed as shown in an image 30d, for example.

Further, in the case where the user E, who is a friend of the user B, is an acquaintance of the user C, is permitted to access the personal information of the user B, and is not permitted to access the personal information of the user C, accesses the image 30, only the personal information of the user B may be displayed. For example, the image 30 may be displayed to the user E in a manner as shown in an image 30e1 or an image 30e2 of FIG. 12. That is, in the image 30e1, the facial image and the tag of the user B whose personal information being permitted to be accessed are displayed, but the tag of the user C is not displayed. Further, in the image 30e2, the facial image and the tag of the user B are displayed but the tag of the user C is not displayed, and the face part of the face photograph is being blurred.

### 4-5. Fifth Example

Next, with reference to FIG. 13 and FIG. 14, a fifth example of the personal information-access control of the information processing system according to the present embodiment will be described. Note that, in the fifth example, the description will be made focused on the reliability added to the personal information.

The reliability added to the personal information may be set to a fixed value, for example, and may also be determined based on the relationship between the attribution user and the disclosure user. A rule for adding the reliability in this case may be as shown in the following Table 3, for example.

| Relationship between attribution user | Reliability of data available |
|---|---|
| and disclosure user | for viewing |
| User himself/herself | 0-100 |
| Spouses, Parent/Child | 10-100 |
| Best friends | 20-100 |
| Friends | 50-100 |
| Acquaintances | 90-100 |
| Strangers | 100-100 |

For example, as shown in FIG. 13, let us assume a case where a user I makes an image 40 public. In the image 40, a user J is included as a subject. However, let us assume that the user I, who is an acquaintance of the user J and of a user H but is not very close with them, adds a tag “user H” to the image 40 by mistake.

In this way, there is the case where the personal information added by a person who is not very close may be inaccurate. Accordingly, here, the reliability to be added to the personal information is determined based on the reliability between the disclosure user and the attribution user.

For example, in this case, the user H who is the attribution user and the user I who is the disclosure user are acquaintances with each other. Accordingly, referring to the above Table 3, the reliability of 10 is added to the image 40. When the access availability is determined by using the thus determined reliability 10 of the personal information and a reliability between the access user and the attribution user, the result thereof is as shown in FIG. 14. That is, in this case, the user H himself/herself and a user K, who is a spouse of the user H, is permitted to access the image 40. Accordingly, the image 40 is made public only to the users who can determine that the subject of the image 40 is not the user H. Therefore, the image 40 is not made public to the users who may mistakenly recognize the person shown in the image 40 as the user H.

### 5. HARDWARE CONFIGURATION EXAMPLE

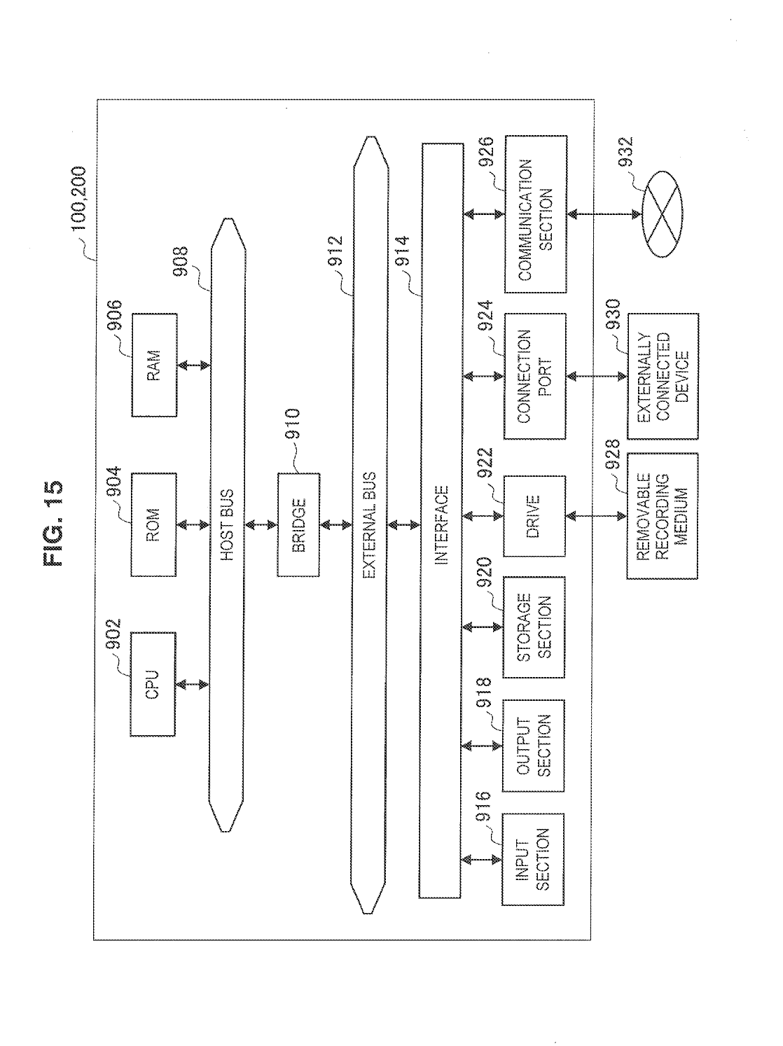

The function of each structural element of the server device 100 and the terminal device 200 described above can be realized by using the hardware configuration shown in FIG. 15, for example. That is, the function of each structural element is realized by controlling the hardware shown in FIG. 15 by using a computer program. Note that the mode of this hardware is arbitrary, and may be a personal computer, a mobile information terminal such as a mobile phone, a PHS or a PDA, a game machine, or various types of information appliances. “PHS” is an abbreviation for “personal handy-phone system”. Further, “PDA” is an abbreviation for “personal digital assistant”. FIG. 15 is a block diagram showing an example of a hardware configuration of the server device according to the embodiment.

As shown in FIG. 15, the hardware mainly includes a CPU 902, a ROM 904, a RAM 906, a host bus 908, and a bridge 910. In addition, the hardware includes an external bus 912, an interface 914, an input section 916, an output section 918, a storage section 920, a drive 922, a connection port 924, and a communication section 926. Note that “CPU” is an abbreviation for “central processing unit”. Further, “ROM” is an abbreviation for “read only memory”. Still further, “RAM” is an abbreviation for “random access memory”.

The CPU 902 functions as an arithmetic processing unit or a control unit, and controls the overall operation or a part of the operation of each structural element based on various programs recorded in the ROM 904, the RAM 906, the storage section 920, or a removable recording medium 928. The ROM 904 is a unit for storing a program to be read by the CPU 902, data used for calculation, and the like. The RAM 906 temporarily or permanently stores a program to be read by the CPU 902, various parameters that appropriately change when executing the program, and the like.

Those structural elements are connected to each other via, for example, the host bus 908 capable of performing high-speed data transmission. On the other hand, the host bus 908 is connected via the bridge 910 to the external bus 912 whose data transmission speed is relatively low, for example. Further, as the input section 916, there are used a mouse, a keyboard, a touch panel, a button, a switch, or a lever, for example. Also, the input section 916 may be a remote control that can transmit a control signal by using an infrared ray or other radio waves.

The output section 918 is, for example, a display device such as a CRT, an LCD, a PDP, or an ELD, an audio output device such as a speaker or headphones, a printer, a mobile phone, or a facsimile, that can visually or auditorily notify a user of acquired information. Note that, “CRT” is an abbreviation for “cathode ray tube”. Further, “LCD” is an abbreviation for “liquid crystal display”. Still further, “PDP” is an abbreviation for “plasma display panel”. Also, “ELD” is an abbreviation for “electro-luminescence display”.

The storage section 920 is a device for storing various data. The storage section 920 is, for example, a magnetic storage device such as an HDD, a semiconductor storage device, an optical storage device, or a magneto-optical storage device. Note that “HDD” is an abbreviation for “hard disk drive”.

The drive 922 is a device that reads information recorded on the removal recording medium 928 such as a magnetic disk, an optical disc, a magneto-optical disk, or a semiconductor memory, or writes information in the removal recording medium 928. The removal recording medium 928 is, for example, a DVD medium, a Blu-ray medium, an HD-DVD medium, various types of semiconductor storage media, or the like. Of course, the removal recording medium 928 may be, for example, an IC card having a non-contact IC chip mounted thereon or an electronic device. Note that “IC” is an abbreviation for “integrated circuit”.

The connection port 924 is a port such as an USB port, an IEEE1394 port, a SCSI, an RS-232C port, or a port for connecting an externally connected device 930 such as an optical audio terminal. The externally connected device 930 is, for example, a printer, a mobile music player, a digital camera, a digital video camera, or an IC recorder. Note that “USB” is an abbreviation for “universal serial bus”. Also, “SCSI” is an abbreviation for “small computer system interface”.

The communication section 926 is a communication device to be connected to the network 932, and is, for example, a communication card for a wired or wireless LAN, Bluetooth (registered trademark), or WUSB, an optical communication router, an ADSL router, or various communication modems. The network 932 connected to the communication section 926 is configured from a wire-connected or wirelessly connected network, and is the Internet, a home-use LAN, infrared communication, visible light communication, broadcasting, or satellite communication, for example. Note that “LAN” is an abbreviation for “local area network”. Also, “WUSB” is an abbreviation for “wireless USB”. Further, “ADSL” is an abbreviation for “asymmetric digital subscriber line”.

### 6. CONCLUSION

As described above, by using the technology suggested in the present disclosure, the access control to the personal information is performed based on the distance between the attribution user and the access user. Accordingly, the attribution user himself/herself can manage the disclosure range of his/her personal information. Therefore, it can be prevented that the personal information is made public in a form that the user to whom the personal information belongs is unable to know. Further, the reliability added to the personal information is determined based on the relationship between the disclosure user and the attribution user, and thus, high reliability can be set for information made public by a close person and low reliability can be set for information made public by a person who is not very close. In this way, the accuracy of the information that is made public can be enhanced.

It should be understood by those skilled in the art that various modifications, combinations, sub-combinations and alterations may occur depending on design requirements and other factors insofar as they are within the scope of the appended claims or the equivalents thereof.

Note that, in the present specification, the steps written in the flowchart may of course be processed in chronological order in accordance with the stated order, but may not necessarily be processed in the chronological order, and may be processed individually or in a parallel manner. It is needless to say that, in the case where the steps are processed in the chronological order, the order of the steps may be changed appropriately according to circumstances.

Additionally, the present technology may also be configured as below.
(A1) A method comprising: controlling disclosure of data to a first user based, at least in part, on first information indicating a closeness of a relationship between the first user and a second user, wherein the second user is a subject of the data, and wherein the data is provided by a third user.
(A2) The method of (A1), further comprising receiving, from the second user, the first information.
(A3) The method of (A1), further comprising analyzing second data to determine the first information indicating the closeness of the relationship between the first user and the second user.
(A4) The method of (A3), wherein the first user and/or the second user is a subject of the second data.
(A5) The method of (A3) to (A4), wherein information specifies that the first user and/or the second user is a subject of the second data.
(A6) The method of any of (A3) to (A5), wherein the second data comprises an educational history, employment information, user profile information, a photograph, a video, and/or text.
(A7) The method of any of (A1) to (A6), wherein: the disclosure of the data to the first user is further controlled based on second information indicating a reliability of third information, and the third information specifies that the second user is a subject of the data.
(A8) The method of (A7), wherein controlling disclosure of the data to the first user is further based, at least in part, on a comparison of the first information and the second information.
(A9) The method of any of (A7) to (A8), wherein the second information indicating the reliability of the third information depends on a closeness of a relationship between the second user and a user who is a provider of the third information.
(A10) The method of any of (A1) to (A9), wherein: the disclosure of the data to the first user is further controlled based on fourth information indicating a closeness of a relationship between the first user and a user who is a provider of the third information.
(A11) The method of (A7), further comprising controlling disclosure of the third information.
(B1) The method of any of (A9) to (A10), wherein the user who is the provider of the third information is the third user.
(A12) The method of (A11), wherein controlling the disclosure of the third information includes determining whether to allow upload of the third information based, at least in part, on fourth information indicating a closeness of a relationship between the first user and a user who is a provider of the third information.
(A13) The method of any of (A1) to (A12), wherein controlling disclosure of the data comprises denying the first user access to the data.
(A14) The method of any of (A1) to (A12), wherein: the data comprises the third information, and controlling disclosure of the data comprises denying the first user access to a portion of the data that includes the third information, and granting the first user access to a second portion of the data.
(A15) The method of (A14), wherein granting the first user access to the second portion of the data comprises altering the second portion of the data such that a subject of the second portion of the data is obscured.
(A16) The method of (A1), wherein: the first and second users are users of a membership-based service, and the method is performed by a provider of a membership-based service.
(A17) A method comprising: controlling disclosure of data to a first user based, at least in part, on first information indicating a closeness of a relationship between the first user and a second user, and on second information indicating a reliability of third information, wherein the third information specifies that the second user is a subject of the data.
(A18) The method of (A17), wherein the second information indicating the reliability of the third information depends on a closeness of a relationship between the second user and a user who is a provider of the third information.
(B2) The method of any of (A17) to (A18), wherein: the disclosure of the data to the first user is further controlled based on fourth information indicating a closeness of a relationship between the first user and the user who is the provider of the third information.
(A19) A computer-readable storage medium having recorded thereon a program which, when executed by a computer, causes the computer to perform a method comprising: controlling disclosure of data to a first user based, at least in part, on first information indicating a closeness of a relationship between the first user and a second user, wherein the second user is a subject of the data, and wherein the data is provided by a third user.
(A20) An apparatus comprising: at least one processor; and a computer-readable storage medium storing a program which, when executed by the at least one processor, performs a method including: controlling disclosure of data to a first user based, at least in part, on first information indicating a closeness of a relationship between the first user and a second user, and on second information indicating a reliability of third information, wherein the third information specifies that the second user is a subject of the data.
(B3) A method comprising: controlling disclosure of information specifying a subject of data, wherein controlling the disclosure of the information includes determining whether to allow a provider of the information to upload the information based, at least in part, on other information indicating a closeness of a relationship between the subject and the provider of the information.
(B4) An information processing apparatus, including: a first distance acquisition section which acquires a first distance between an attribution user to whom personal information belongs and an access user who accesses the personal information, and a control section which controls a disclosure state of the personal information based on the first distance.
(B5) An information processing method, including: acquiring a first distance between an attribution user to whom personal information belongs and an access user who accesses the personal information, and controlling a disclosure state of the personal information based on the first distance.
(B6) A program for causing a computer to function as an information processing apparatus including a first distance acquisition section which acquires a first distance between an attribution user to whom personal information belongs and an access user who accesses the personal information, and a control section which controls a disclosure state of the personal information based on the first distance.
(B7) An information processing system, including: a terminal device of an access user who accesses a server which makes personal information public, and the server including a first distance acquisition section which acquires a first distance between an attribution user to whom the personal information belongs and the access user, and a control section which controls a disclosure state of the personal information based on the first distance.
(B8) According to some embodiments of the present disclosure described above, the disclosure state of the personal information is controlled based on the relationship between the attribution user to whom the personal information belongs and the access user who accesses the personal information.
(C1) An information processing apparatus including: a first distance acquisition section which acquires a first distance between an attribution user to whom personal information belongs and an access user who accesses the personal information; and a control section which controls a disclosure state of the personal information based on the first distance.
(C2) The information processing apparatus according to (C1), further including: a second distance acquisition section which acquires a second distance between a disclosure user who makes the personal information public and the access user, wherein the control section controls the disclosure state of the personal information further based on the second distance.
(C3) The information processing apparatus according to (C1) or (C2), wherein the personal information is added with a reliability for limiting a disclosure range of the personal information, and wherein the control section controls the disclosure state of the personal information based on the reliability added to the personal information.
(C4) The information processing apparatus according to (C3), wherein the reliability is added based on a third distance between the attribution user and the disclosure user.
(C5) The information processing apparatus according to any one of (C1) to (C4), wherein the distance is set based on a group added to a user.
(C6) The information processing apparatus according to any one of (C1) to (C5), wherein the control section controls the disclosure state by controlling whether to upload the personal information to a server device.
(C7) The information processing apparatus according to any one of (C1) to (C6), wherein the control section controls the disclosure state by controlling whether to make the personal information public to the access user.
(C8) The information processing apparatus according to any one of (C1) to (C7), wherein the personal information is tag information added to an image.
(C9) The information processing apparatus according to any one of (C1) to (C7), wherein the personal information is a character string in a document.
(C10) The information processing apparatus according to any one of (C1) to (C9), wherein the attribution user and the access user are each a user of a membership-based service.
(C11) The information processing apparatus according to (C10), wherein the membership-based service is a social networking service.
(C12) An information processing method including: acquiring a first distance between an attribution user to whom personal information belongs and an access user who accesses the personal information; and controlling a disclosure state of the personal information based on the first distance.
(C13) A program for causing a computer to function as an information processing apparatus including: a first distance acquisition section which acquires a first distance between an attribution user to whom personal information belongs and an access user who accesses the personal information, and a control section which controls a disclosure state of the personal information based on the first distance.
(C14) An information processing system including: a terminal device of an access user who accesses a server which makes personal information public; and the server including: a first distance acquisition section which acquires a first distance between an attribution user to whom the personal information belongs and the access user, and a control section which controls a disclosure state of the personal information based on the first distance.

What is claimed is:

1. A method comprising:
controlling disclosure of data to a first user based, at least in part, on first information indicating a closeness of a relationship between the first user and a second user, wherein the second user is a subject of the data, and wherein the data is provided by a third user.

2. The method of claim 1, further comprising receiving, from the second user, the first information.

3. The method of claim 1, further comprising analyzing second data to determine the first information indicating the closeness of the relationship between the first user and the second user.

4. The method of claim 3, wherein the first user and/or the second user is a subject of the second data.

5. The method of claim 3, wherein information specifies that the first user and/or the second user is a subject of the second data.

6. The method of claim 3, wherein the second data comprises an educational history, employment information, user profile information, a photograph, a video, and/or text.

7. The method of any of claim 1, wherein:
the disclosure of the data to the first user is further controlled based on second information indicating a reliability of third information, and
the third information specifies that the second user is a subject of the data.

8. The method of claim 7, wherein controlling disclosure of the data to the first user is further based, at least in part, on a comparison of the first information and the second information.

9. The method of claim 8, wherein the second information indicating the reliability of the third information depends on a closeness of a relationship between the second user and a user who is a provider of the third information.

10. The method of claim 1, wherein:
the disclosure of the data to the first user is further controlled based on fourth information indicating a closeness of a relationship between the first user and a user who is a provider of the third information.

11. The method of claim 7, further comprising controlling disclosure of the third information.

12. The method of claim 11, wherein controlling the disclosure of the third information includes determining whether to allow upload of the third information based, at least in part, on fourth information indicating a closeness of a relationship between the first user and a user who is a provider of the third information.

13. The method of claim 1, wherein controlling disclosure of the data comprises denying the first user access to the data.

14. The method of claim 1, wherein:
the data comprises the third information, and
controlling disclosure of the data comprises denying the first user access to a portion of the data that includes the third information, and granting the first user access to a second portion of the data.

15. The method of claim 14, wherein granting the first user access to the second portion of the data comprises altering the second portion of the data such that a subject of the second portion of the data is obscured.

16. The method of claim 1, wherein:
the first and second users are users of a membership-based service, and
the method is performed by a provider of a membership-based service.

17. A method comprising:
controlling disclosure of data to a first user based, at least in part, on first information indicating a closeness of a relationship between the first user and a second user, and on second information indicating a reliability of third information, wherein the third information specifies that the second user is a subject of the data.

18. The method of claim 17, wherein the second information indicating the reliability of the third information depends on a closeness of a relationship between the second user and a user who is a provider of the third information.

19. A computer-readable storage medium having recorded thereon a program which, when executed by a computer, causes the computer to perform a method comprising:
controlling disclosure of data to a first user based, at least in part, on first information indicating a closeness of a relationship between the first user and a second user, wherein the second user is a subject of the data, and wherein the data is provided by a third user.

20. An apparatus comprising:
at least one processor; and
a computer-readable storage medium storing a program which, when executed by the at least one processor, performs a method including: controlling disclosure of data to a first user based, at least in part, on first information indicating a closeness of a relationship between the first user and a second user, and on second information indicating a reliability of third information, wherein the third information specifies that the second user is a subject of the data.
